(19) United States
(12) Patent Application Publication
(10) Pub. No.: US 2021/0048113 A1
(43) Pub. Date: Feb. 18, 2021

(54) THREADLESS VALVE

(71) Applicant: Schrader-Bridgeport International, Inc., Altavista, VA (US)

(72) Inventors: Gregory D. Trulear, Forest, VA (US); Major H. Gilbert, Gladys, VA (US); Jeffrey A. Schultz, Pittsville, VA (US)

(73) Assignee: Schrader-Bridgeport International, Inc., Altavista, VA (US)

(21) Appl. No.: 16/540,297

(22) Filed: Aug. 14, 2019

(51) Int. Cl. F16K 15/06; F16K 25/00

(52) U.S. Cl. CPC F16K 15/063; B60H 1/00585; F16K 25/005

(57) ABSTRACT

A check valve may include a valve body forming a central passage extending from a first side of the valve body to a second side of the valve body. A valve pin may be located within the central passage, where the valve pin includes a sealing head that selectively contacts a valve seat of the valve body to control flow of a fluid through the central passage. A spring may be included, where the spring has a first end that is fixed relative to the valve pin and a second end fixed to a spring seat. The valve body and the spring seat may be fixed to one another without the use of threads.

### TECHNICAL FIELD

The present disclosure generally relates to a valve that regulates the flow of fluid in at least one direction, such as a check valve or charge valve for an air conditioning system.

### BACKGROUND

Check valves, such as those used to connect a refrigerant source to an air conditioning system, are designed to prevent backward flow of a liquid. For example, when coupled to a refrigerant charging line, a check valve may allow flow of the refrigerant in only one direction. Typically, check valves have a valve body which defines an axially-oriented passageway (or “central passage”). An annular valve seat is disposed around the passageway, and a spring-loaded valve pin is mounted inside the central passage. The valve pin seats against the valve seat to prevent flow through the central passage when the check valve pin is closed, and it is spaced from the valve seat when the check valve is open to permit flow through the central passage.

In certain applications, such as those where a check valve is used with an automotive air conditioning system, the valve body includes threaded portions, along with an outer profile shaped to engage a wrench so the valve body can be screwed into and removed from the air conditioning system. Further, the valve body typically includes two separate segments that are connected via threads, where separation of the two segments provides access to the central portion of the passageway to allow installation of the valve pin. O-rings are typically included (e.g., at least one O-ring for each set of threads) to prevent leakage.

### BRIEF DESCRIPTION OF THE DRAWINGS

The embodiments of the present disclosure may be better understood with reference to the following drawings and description. The components in the figures are not necessarily to scale, with emphasis instead being placed upon illustrating the principles of the present disclosure. Moreover, in the figures, like referenced numerals designate similar or identical features.

FIG. 1 is an illustration showing a perspective view of a threadless check valve in accordance with certain aspects of the present disclosure.

FIG. 2 is an illustration showing a front view of the threadless check valve depicted in FIG. 1.

FIG. 3 is an illustration showing a section view of the threadless check valve depicted in FIGS. 1-2 about section A-A (shown in FIG. 2).

FIG. 4 is an illustration showing a valve body of the threadless check valve depicted in FIGS. 1-3.

FIG. 5 is an illustration showing a spring seat of the threadless check valve depicted in FIGS. 1-3.

FIG. 6 is an illustration showing a valve pin of the threadless check valve depicted in FIGS. 1-3.

FIG. 7 is an illustration showing a portion of an air conditioning system where the threadless check valve depicted in FIGS. 1-3 is installed in accordance with certain aspects of the present disclosure.

### DETAILED DESCRIPTION

One general aspect of the present disclosure includes an embodiment of a valve. The valve may include a valve body forming a central passage extending from a first side of the valve body to a second side of the valve body; a valve pin located within the central passage, where the valve pin includes a sealing head that selectively contacts a valve seat of the valve body to control flow of a fluid through the central passage; a spring having a first end that is fixed relative to the valve pin; and a spring seat that is fixed relative to a second end of the spring. The spring seat may include an outer-facing surface that contacts an inner-facing surface of the valve body to secure the spring seat relative to the valve body. At least one of the first side and the second side of the valve body may be configured to couple to a separate tubing component in a threadless manner.

Optionally, the first side of the valve body includes a second inner-facing surface that defines a portion of the central passage, where the second inner-facing surface is configured to receive a surface of the separate tubing component, and where the inner-facing surface of the first side lacks threads. In some applications, an entirety of the valve body is threadless. The valve body may be formed as a single unitary piece, optionally including thermoplastic material. Optionally, the valve body includes an angled surface located adjacent to the inner-facing surface and that is angled relative to a longitudinal axis of the central passage (e.g., where the angle between the angled surface and the longitudinal axis of the central passage is at least about 5 degrees). Optionally, the spring seat includes a flange that abuts a flange surface of the valve body, where the spring seat and the valve body are secured via an ultrasonic weld. Optionally, at least one of the first side and the second side of the valve body includes an angled surface located adjacent to a terminus of the central passage.

Various aspects are described below with reference to the drawings in which like elements generally are identified by like numerals. The relationship and functioning of the various elements of the aspects may be better understood by reference to the following detailed description. However, aspects are not limited to those illustrated in the drawings or explicitly described below. It also should be understood that the drawings are not necessarily to scale, and in certain instances details may have been omitted that are not necessary for an understanding of aspects disclosed herein, such as conventional fabrication and assembly.

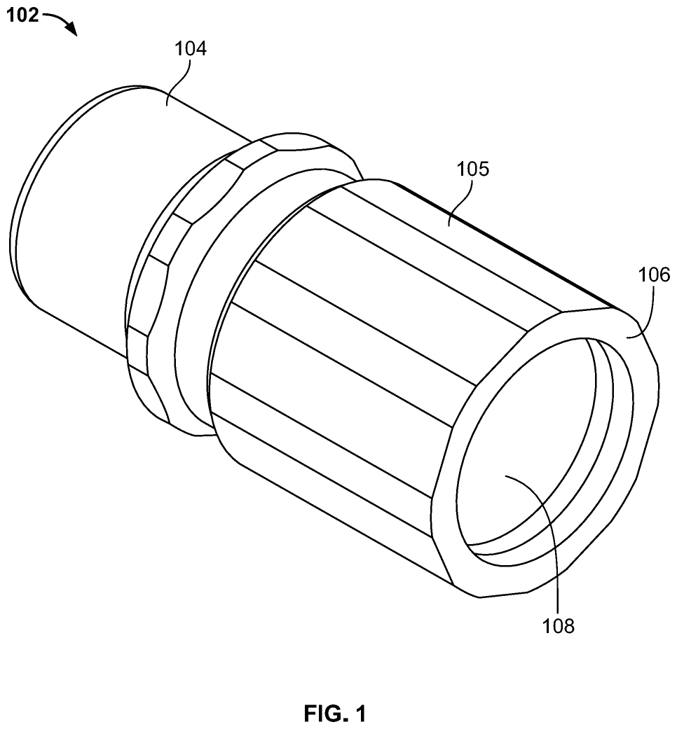

FIG. 1 shows a perspective view of a valve 102. In this disclosure, the valve 102 is described as being used with an air conditioning system (“AC system”), particularly for providing communication between a charged refrigerant source and the tubing forming the primary refrigeration cycle. The valve 102 may be used for any other suitable application, particularly those where single-direction flow of a fluid (i.e., liquid or gas) is desired. In the depicted embodiment, the valve 102 includes a first side 104 designed to couple to the refrigerant source and a second side 106 designed to couple to the refrigeration cycle. During normal operation, refrigerant may flow into the first side 104, through a central passage 108, and out of the second side 106 (and/or vice versa). However, it is also contemplated that backward flow may be allowed (e.g., when the valve 102 is actuated via a separate pin or other component, as described in more detail below).

Notably, at least certain portions of the valve 102, and potentially the entirety of the valve 102, may be threadless. For example, and as discussed in more detail below, the first side 104 may act as a threadless male coupling (or alternatively a female coupling). During assembly into an air conditioning system, the first side 104 may be inserted into a first tubing component (e.g., in fluid communication with a charged refrigerant source). Similarly, the second side 106 may act as a threadless female coupling (or alternatively a male coupling) for receiving and securing to a second tubing component (e.g., in fluid communication with a refrigeration cycle). Whether threads are used or not, the valve 102 may include wrench-receiving features 105, which may facilitate the holding and maneuvering of the valve 102 during the assembly of an air conditioning system.

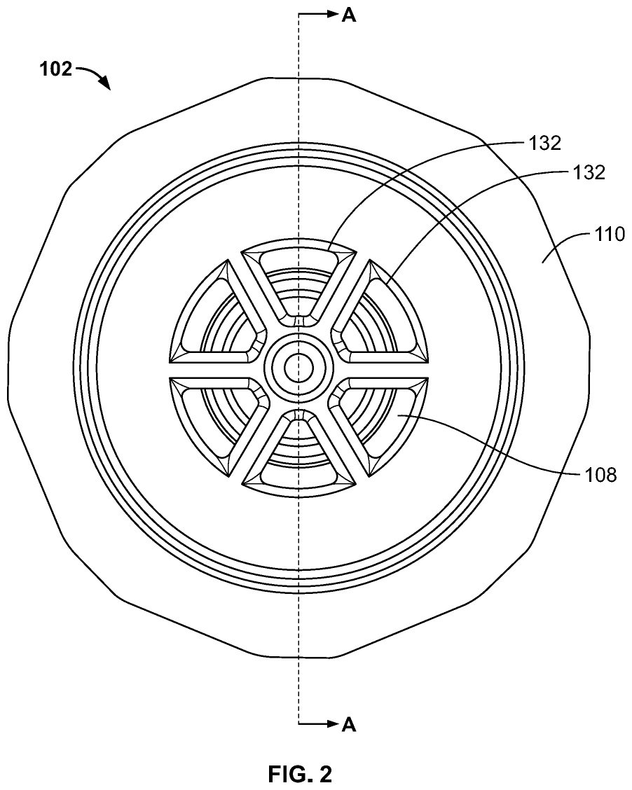

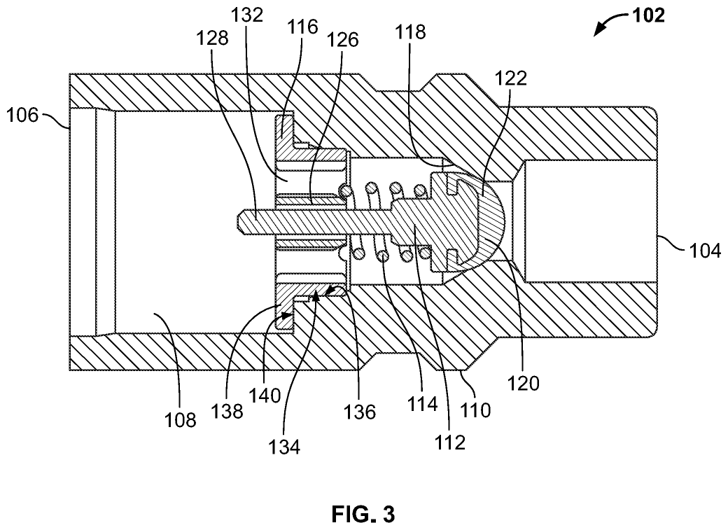

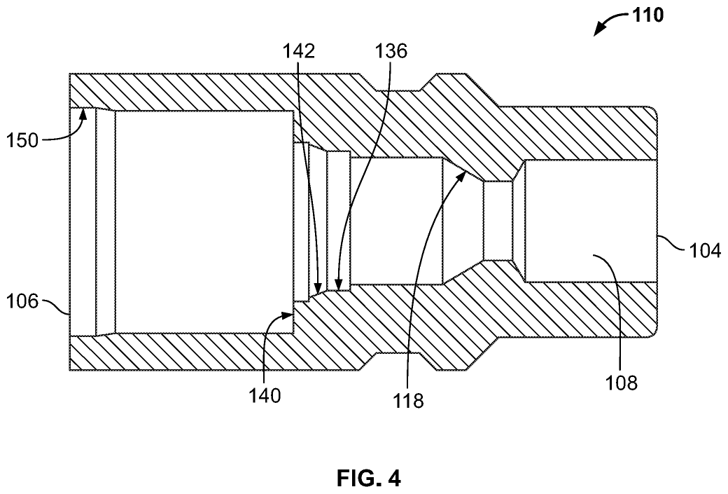

FIG. 2 shows a front view of the valve 102, and FIG. 3 shows a section view about section A-A of FIG. 2. Referring to FIG. 3, the valve 102 may generally include a valve body 110 that defines the central passage 108, a valve pin 112 within the central passage 108, a spring 114 that provides a spring force to the valve pin 112, and a spring seat 116 that retains the spring 114 and valve pin 112 in their operational positions. The valve body 110, the spring seat 116, and the valve pin 112 are shown in isolation in FIGS. 4, 5, and 6, respectively.

Referring to FIGS. 3-6, the valve body 110 may have a valve seat 118, which may include a surface that is angled relative to the longitudinal direction of the central passage 108 and towards a sealing head 120 of the valve pin 112. To control fluid communication between the first side 104 of the central passage 108 and the second side 106 of the central passage 108, the valve pin 112 may be movable such that the sealing head 120 can be moved into and out of engagement (e.g., contact) with the valve seat 118. For example, when in an open (non-sealing) state (not shown), the sealing head 120 may be spaced from the valve seat 118 such that fluid can pass between the sealing head 120 and the valve seat 118. By contrast, when the valve 102 is in a closed (sealing) state, the sealing head 120 may abut or contact the valve seat 118 (as shown in FIG. 3) such that fluid communication between the first side 104 and the second side 106 of the central passage 108 is interrupted. The valve pin 112 may be formed with any suitable material, such as a plastic material, a metal (e.g., brass), another suitable material, or a combination thereof. Optionally, the sealing head 120 may include a material that is relatively compliant (e.g., a rubber) relative to the remainder of the valve pin 112 such that the contact portion 122 of the sealing head 120 compresses against the valve seat 118 for enhanced sealing. Alternatively, the valve pin 112 may be formed as a single unitary piece (e.g., having the same or similar exterior profile as the depicted two-piece version).

A spring 114 may be included to influence the position of the valve pin 112. The spring 114 may be formed with any suitable material (or combination of materials), such as a metal material (e.g., 302 stainless steel) or a non-metal material (e.g., a plastic). In the depicted embodiment, the spring 114 is a helical compression spring that exerts opposing forces on the sealing head 120 of the valve pin 112 and the spring seat 116. Since the valve pin 112 is fixed relative to the valve body 110 (as discussed in more detail below), the spring 114 causes a tendency for the sealing head 120 to abut the valve seat 118, absent other forces. Thus, in order for the valve 102 to move from the closed (sealing) state to the open (non-sealing) state, an external force must be present that acts on the valve pin 112. For example, when the valve 102 is designed to allow flow in only one direction, a pressure between the first side 104 and the second side 106 of the central passage 108 may cause the valve 102 to open (e.g., where the pressure difference is sufficient to overpower the spring 114, thereby moving the valve pin 112 away from the valve seat 118). Additionally or alternatively, a separate pin or other valve opening device may be used (not shown), which may be inserted through the first side 104 and placed into contact with the sealing head 120 to move the valve pin 112 away from the valve seat 118 (e.g., potentially allowing two-way flow through the valve 102). Such an embodiment may be advantageous where the valve 102 is used for both charging and discharging refrigerant and another fluid from a system under certain conditions.

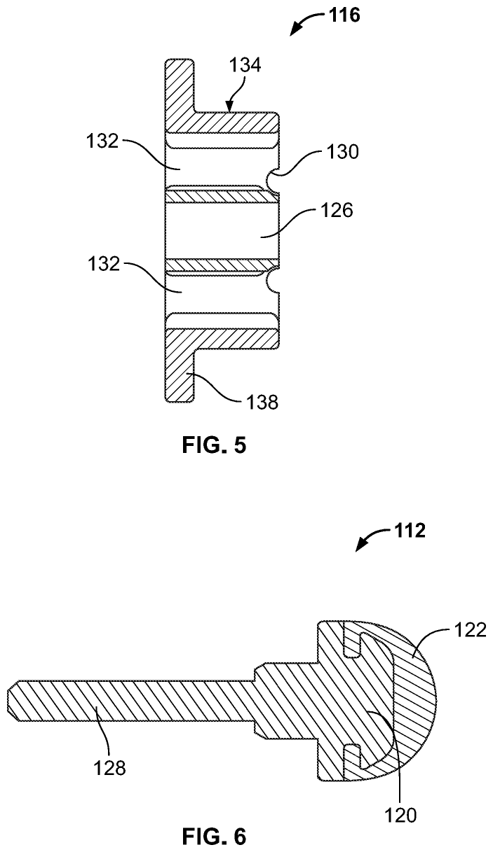

The spring seat 116 may include a pin recess 126 for receiving a tail 128 of the valve pin 112. An optional spring groove 130 (labeled FIG. 5 only) of the spring seat 116 may be included for receiving a portion of the coil of the spring 114 (and, while not shown, it is contemplated that the valve pin 112 may also include a groove and/or other feature for interfacing with the spring 114). Further, the spring seat 116 may include at least one opening 132 (also shown in FIG. 2) such that the pin recess 126 does not interrupt fluid communication through the central passage 108 when inserted into the valve body 110.

The components of the valve 102 may each be formed as single unitary pieces (rather than separately formed pieces that are secured together). For example, the valve body 110 may be molded or otherwise formed (e.g., via 3D printing or another suitable process) as a single unitary piece of a suitable material, such as a metal or plastic. Without limitation, the valve body 110 may be fully formed via a single injection molding, blow molding, or extrusion process using a thermoplastic material, such as a polyamide thermoplastic material (or other type). A specific example of a material that may be used to form the valve body 110 is a material marketed and sold under the PA6/10 line of Radilon® polyamide engineered polymer (or co-polymer) materials sold by RadiciGroup of Gandino, Italy. Advantageously, forming the valve body 110 as a single, unitary piece may make simplify and increase the efficiency of the assembly and installation of the valve 102. Further, providing a unitary piece (rather than a segmented body that is threaded together) may avoid the need for threads (and associated O-rings), which may decrease the likelihood of leaks along with the number of components needed to assemble the valve 102.

Like the valve body 110, the spring seat 116 may also (or alternatively) be formed as a single, unitary piece (e.g., via a molding process or another suitable process), and it may be formed with any suitable material (such as a metal or plastic, including the specific Radilon® example discussed above). Further, it is contemplated that the valve body 110 and the spring seat 116 may be formed as the same single, unitary piece (although such an embodiment is not shown in the present figures). An outer-facing surface 134 of the spring seat 116 may be sized to engage a respective inner-facing surface 136 of the valve body 110 when the valve 102 is assembled. During installation of the spring seat 116 (which may occur simultaneously with installation of the valve pin 112 and the spring 114), the spring seat 116 be inserted into the second side 106 of the central passage 108 (which may have an inner diameter that is larger than the largest diameter of the spring seat 116 such that the spring seat 116 is freely movable). While inside the second side 106 of the central passage 108, the spring seat 116 may be moved (in its depicted orientation of FIG. 3) towards the first side 104 of the central passage 108 until it reaches its operational position. Optionally, a flange 138 may be included and configured to contact a flange surface 140 of the valve body 110 when the spring seat 116 is properly positioned. Further, to facilitate proper positioning, the valve body 110 may include an angled surface 142 (labeled in FIG. 4 only) located adjacent to the inner-facing surface 136, which may guide the spring seat 116 as it is maneuvered towards its operational position. Without limitation, the angled surface 142 may be angled between about 10 degrees and about 40 degrees relative to the longitudinal axis of the central passage 108, such as about 25 degrees in certain exemplary embodiments.

At least one of the outer-facing surface 134 of the spring seat 116 and the inner-facing surface 136 of the valve body 110 may be threadless. In some embodiments, the spring seat 116 may be sufficiently retained in place during normal operation via an interference fit. Additionally or alternatively, the securement of the spring seat 116 relative to the valve body 110 may be enhanced via another suitable manner, such as via the use of an adhesive (e.g., LOCTITE®) at the place of contact. In a particular exemplary embodiment, an ultrasonic welding and/or another welding, friction, laser, or any/or any other suitable process may be used once the spring seat 116 is properly placed, whereby high-frequency ultrasonic acoustic vibrations are applied at least to the contact area between the outer-facing surface 134 of the spring seat 116 and the inner-facing surface 136 of the valve body 110. These ultrasonic acoustic vibrations may form a solid-state weld or joint. Without limitation, an ultrasonic weld may be advantageous since such an embodiment does not require bolts, nails, soldering materials, adhesives, or any other external component(s) for securing the two unitary pieces together. Further, due to the low-temperature nature of ultrasonic welding, the temperature during assembly may remain below the melting point of the materials forming the spring seat 116 and/or the valve body 110, thereby preventing undesirable deformation.

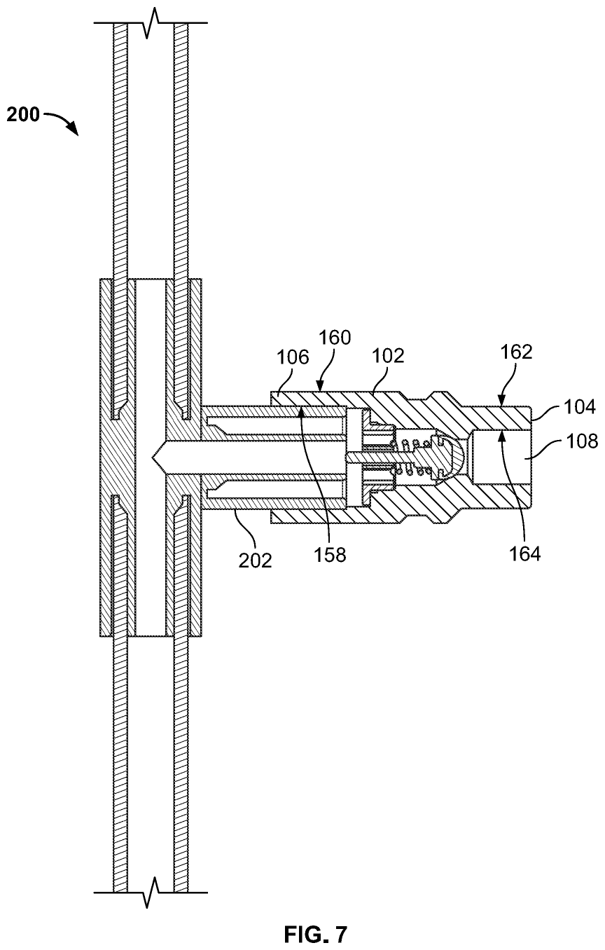

Similarly, the valve body 110 may couple to other components (e.g., tubing components within an air conditioning unit) in a threadless manner. For illustration purposes, FIG. 7 shows a portion of an air conditioning system 200 that includes the valve 102. As shown, the second side 106 of the valve 102 acts as a female coupling for receiving a male counterpart, and specifically a tube extending from tee adapter 202. Referring back to FIG. 4, the valve body 110 may include an angled surface 150 near the terminus of the central passage 108 configured to guide the male coupling into place. For example, and without limitation, the angled surface 150 may be angled between about 5 degrees and about 20 degrees, such as about 10 degrees in certain exemplary embodiments. While not shown, the first side 104 of the valve 102 may engage a separate tubing component (e.g., a charged refrigeration source) in a similar manner (e.g., where the first side 104 of the valve 102 acts as one of a male and female coupling). Once secured in place, such components may be fixed without the use of threads. More particularly (with reference to FIG. 7), an inner surface 158 may lack the use of functional threads, or threads used to permanently secure the second side 106 of the valve 102 to another component of the system 200. As an alternative, the valve 102 may be operationally secured via ultrasonic welding (as discussed above) or another suitable process, such as laser welding, friction spin welding, etc. Similarly, one or more of surfaces 160, 162, and/or 164 may be threadless and used as a male or female (or other) connector for securing the valve 102 to another component. While not shown in FIG. 7, it is further contemplated that at least a portion of the valve 102 (e.g., the valve body 110 described above) may be formed with the tee adapter 202, and/or another tubing component of the air conditioning system 200, as a single, unitary piece.

The threadless nature of the valve 102 may be advantageous for a variety of reasons. For example (and without limitation), the threadless nature of the valve 102 may prevent the need to include O-rings (thereby reducing installation complexity and cost), particularly where ultrasonic welding is used, as an ultrasonic weld alone may provide a sufficient barrier to separate internal fluid passages from the ambient environment. In some embodiments, the entirety of the valve body 110 may be threadless (as shown).

While various embodiments of the present disclosure have been described, the present disclosure is not to be restricted except in light of the attached claims and their equivalents. One skilled in the relevant art will recognize that numerous variations and modifications may be made to the embodiments described above without departing from the scope of the present invention, as defined by the appended claims. Moreover, the advantages described herein are not necessarily the only advantages of the present disclosure and it is not necessarily expected that every embodiment of the present disclosure will achieve all of the advantages described.

We claim:

1. A valve comprising:
a valve body forming a central passage extending from a first side of the valve body to a second side of the valve body;
a valve pin located within the central passage, wherein the valve pin includes a sealing head that selectively contacts a valve seat of the valve body to control flow of a fluid through the central passage;
a spring having a first end that is fixed relative to the valve pin; and
a spring seat that is fixed relative to a second end of the spring,
wherein the spring seat includes an outer-facing surface that contacts an inner-facing surface of the valve body to secure the spring seat relative to the valve body, and
wherein at least one of the first side and the second side of the valve body is configured to couple to a separate tubing component in a threadless manner.

2. The valve of claim 1, wherein the first side of the valve body includes a second inner-facing surface that defines a portion of the central passage, wherein the second inner-facing surface is configured to receive a surface of the separate tubing component, and wherein the inner-facing surface of the first side lacks threads.

3. The valve of claim 1, wherein an entirety of the valve body is threadless.

4. The valve of claim 1, wherein the valve body consists of a single unitary piece.

5. The valve of claim 4, wherein the valve body consists of a thermoplastic material.

6. The valve of claim 1, wherein the valve body includes an angled surface located adjacent to the inner-facing surface, and wherein the angled surface is angled relative to a longitudinal axis of the central passage.

7. The valve of claim 6, wherein an angle between the angled surface and the longitudinal axis of the central passage is at least about 5 degrees.

8. The valve of claim 1, wherein the spring seat includes a flange that abuts a flange surface of the valve body.

9. The valve of claim 1, wherein the spring seat and the valve body are secured via an ultrasonic weld.

10. The valve of claim 1, wherein at least one of the first side and the second side of the valve body includes an angled surface located adjacent to a terminus of the central passage.

11. A valve comprising:
a valve body forming a central passage extending from a first side of the valve body to a second side of the valve body;
a valve pin located within the central passage, wherein the valve pin includes a sealing head that selectively contacts a valve seat of the valve body to control flow of a fluid through the central passage;
a spring having a first end that is fixed relative to the valve pin; and
a spring seat that is fixed relative to a second end of the spring,
wherein the spring seat is fixed relative to the valve body, and
wherein the valve body consists of a single unitary piece.

12. The valve of claim 11, wherein an entirety of the valve body is threadless.

13. The valve of claim 12, wherein the valve body consists of a thermoplastic material.

14. The valve of claim 11, wherein the valve body includes a threadless inner-facing surface that is secured to the spring seat.

15. The valve of claim 14, wherein the spring seat is threadless.

16. The valve of claim 14, wherein the valve body includes an angled surface located adjacent to the threadless inner-facing surface, and wherein an angle between the angled surface and a longitudinal axis of the central passage is at least about 5 degrees.

17. The valve of claim 14, wherein the spring seat is secured to the threadless inner-facing surface via an ultrasonic weld.

18. The valve of claim 11, wherein the valve lacks an O-ring.

19. The valve of claim 11, wherein at least one of the first side and the second side of the valve body includes an angled surface located adjacent to a terminus of the central passage.

20. A valve comprising:
a valve body forming a central passage extending from a first side of the valve body to a second side of the valve body;
a valve pin located within the central passage, wherein the valve pin includes a sealing head that selectively contacts a valve seat of the valve body to control flow of a fluid through the central passage;
a spring having a first end that is fixed relative to the valve pin; and
a spring seat that is fixed relative to a second end of the spring,
wherein the spring seat is fixed relative to the valve body, and
wherein the central passage of the valve are threadless.
